(19) United States
(12) Patent Application Publication
(10) Pub. No.: US 2008/0112785 A1
(43) Pub. Date: May 15, 2008

(54) Assembly for loading and unloading gas cylinders from secondary containment apparatus

(76) Inventor: Rudolph Caparros, Santa Rosa, CA (US)

Correspondence Address: Frank L. Kubler, Esquire, 13261 S.W. 54th Court, Miramar, FL, 33027, US

(21) Appl. No.: 11/598,611

(22) Filed: Nov. 13, 2006

(51) Int. Cl. B60P 1/04

(52) U.S. Cl. 414/468

(57) ABSTRACT

An assembly for loading and unloading supply cylinders containing a hazardous fluid substance into and out of a secondary containment vessel having a substantially horizontal tubular side wall with a vessel longitudinal axis and a vessel closed end with a vessel end wall opposite a vessel open end, the vessel open end being fitted with a vessel hinged door includes a substantially horizontal roller track for positioning substantially co-axially in front of and spaced outwardly from the vessel open end, the roller track including a receiving segment having a receiving segment forward end directed toward the vessel open end and having an opposing receiving segment rearward end, and including a track bridge segment pivotally mounted at the receiving segment forward end, for pivoting from non-deployed position to a substantially horizontal deployed position in which the bridge segment extends substantially from the receiving segment forward end to the vessel open end.

### BACKGROUND OF THE INVENTION

1. Field of the Invention

The present invention relates generally to the field of secondary containment systems for hazardous gases. More specifically the present invention relates to a loading assembly for longitudinally displacing heavy gas cylinders, such as a ton chlorine supply cylinders, into and out of an open end of a secondary containment vessel, the secondary containment vessel typically having a substantially horizontal tubular side wall with a vessel longitudinal axis and a vessel closed end with a vessel end wall opposite the vessel open end, the vessel open end being fitted with a vessel hinged door. The loading assembly includes a substantially horizontal roller track for positioning co-axially in front of and spaced outwardly from the vessel open end, the roller track having a receiving segment forward end directed toward the vessel open end and having an opposing receiving segment rearward end, and a track pivoting bridge segment at the receiving segment forward end preferably pivotally connected to the receiving segment forward end, for pivoting from an upward non-deployed position to a substantially horizontal deployed position in which the bridge segment extends from the receiving segment forward end to the vessel open end. A winch is secured to a winch mounting structure, preferably at the receiving segment rearward end, the winch having a winch cable which is connected to a turnbuckle positioned within the chine of ton cylinder to pull the cylinder out of the vessel after the contents of the cylinder are drained.

The roller track preferably includes two laterally spaced apart and parallel track rails and a series of equally spaced rollers, each roller being rotatably mounted on a roller axle extending between and extending into the track rails. A rail structural member extends between the two track rails at each track end to hold the track rails at a fixed spacing from each other and to provide structural strength and integrity to the roller track. The track rails rest on and are fastened to a spaced series of track support structures in the form of I-beams extending perpendicularly underneath the track rails which elevate and support the roller track. A rearward track support structure is provided underneath the receiving segment rearward end and a forward track support structure is provided underneath the receiving segment forward end, and first and second middle support structures are provided underneath the roller track between the rearward and forward track support structures and extend laterally so that a second roller track can be placed parallel to the first roller track. In this way, a multiple track assembly such as a double track assembly is optionally provided, so that multiple secondary containment vessels can be placed in tandem with each other and loaded and unloaded by the assembly.

2. Description of the Prior Art

There have in recent years been secondary containment vessels for receiving hazardous gas supply cylinders which are leaking or are in danger of leaking, so that the cylinder contents can be drained safely into a receiving structure, these secondary containment vessels having been developed by the present applicant. Such supply cylinders are provided in a variety of sizes, including the one ton cylinder which is heavy for people to manually load into and unload from such vessels.

One prior loading structure is disclosed in U.S. Pat. No. 5,819,787 issued on Oct. 13, 1998 to the present applicant, in which a supply cylinder is placed against a pivoting assembly and manually pivoted into alignment with the open end of a secondary containment vessel. Such manual pivoting is safe and practical only for cylinders much lighter than the ton.

It is thus an object of the present invention to provide an assembly for loading and unloading heavy supply cylinders, such as the one ton sypply cylinder, into and out of secondary containment vessels.

It is another object of the present invention to provide such an assembly which includes a horizontal roller track for minimal resistance longitudinal displacement of a cylinder and a track bridge portion extending to the open end of a secondary containment vessel for delivering a cylinder into the vessel, the bridge portion being retractable to permit the vessel door to open and close.

It is still another object of the present invention to provide such an assembly which includes a winch for pulling heavy supply cylinder out of a secondary containment vessel and onto the track so that potentially injurious manual pulling by workers is not required, and which includes a lateral support area adjacent to the track for storing one or more supply cylinders.

It is still another object of the present invention to provide such an assembly which has a rolling version for convenient positioning of the assembly at the open end of a secondary containment vessel and subsequent removal of the assembly to a storage location until needed again.

It is finally an object of the present invention to provide such an assembly which is sturdy and reliable.

### SUMMARY OF THE INVENTION

The present invention accomplishes the above-stated objectives, as well as others, as may be determined by a fair reading and interpretation of the entire specification.

An assembly is provided for loading and unloading supply cylinders containing a hazardous fluid substance into and out of a secondary containment vessel having a substantially horizontal tubular side wall with a vessel longitudinal axis and a vessel closed end with a vessel end wall opposite a vessel open end, the vessel open end being fitted with a vessel hinged door, the assembly including a substantially horizontal roller track for positioning substantially co-axially in front of and spaced outwardly from the vessel open end, the roller track including a receiving segment having a receiving segment forward end directed toward the vessel open end and having an opposing receiving segment rearward end, and including a track bridge segment pivotally mounted at the receiving segment forward end, for pivoting from non-deployed position to a substantially horizontal deployed position in which the bridge segment extends substantially from the receiving segment forward end to the vessel open end.

The assembly preferably additionally includes a winch mounting structure and a winch secured to the mounting structure, the winch having a winch cable is connected to a turnbuckle positioned within the chine of ton cylinder to displace the supply cylinder longitudinally along the roller track and out of the secondary containment vessel. The bridge segment preferably is pivotally connected to the receiving segment forward end.

The receiving segment and the bridge segment of the roller track preferably each include two laterally spaced apart and substantially parallel track rails interconnected by a series of spaced rollers, each roller being rotatably mounted on a roller axle extending between and into the track rails. The assembly preferably additionally includes a rail structural member extending between the track rails at each longitudinal end of the receiving segment to hold the track rails at a fixed spacing from each other and to provide structural strength and integrity to the receiving segment. The assembly alternatively or additionally includes a spaced series of track support structures, where the track rails rest on and are fastened to the track support structures for elevating and supporting the receiving segment of the roller track.

The track support structures each preferably include an I-beam extending substantially perpendicularly underneath the receiving segment of the roller track. The track support structures preferably include a rearward track support structure underneath the receiving segment rearward end and a forward track support structure underneath the receiving segment forward end.

The track support structures preferably include a first middle support structure and a second middle support structure underneath the receiving segment of the roller track between the rearward track support structure and the forward track support structure, where the first and second middle support structures extend laterally from the receiving segment of the roller track, so that either at least one cylinder can be placed on the first and second middle support structures laterally adjacent to the receiving segment, or a second roller track can be placed parallel to the roller track and two secondary containment vessels can be placed in tandem with each other and loaded and unloaded by the roller track and the second roller track.

A secondary containment and loading system for supply cylinders is further provided including a secondary containment vessel having a substantially horizontal tubular side wall with a vessel longitudinal axis and a vessel closed end with a vessel end wall opposite a vessel open end, the vessel open end being fitted with a vessel hinged door; and a loading assembly for loading and unloading supply cylinders containing a hazardous fluid substance into and out of a secondary containment vessel including a substantially horizontal roller track for positioning substantially co-axially in front of and spaced outwardly from the vessel open end, the roller track including a receiving segment having a receiving segment forward end directed toward the vessel open end and having an opposing receiving segment rearward end, and including a track bridge segment pivotally mounted at the receiving segment forward end, for pivoting from non-deployed position to a substantially horizontal deployed position in which the bridge segment extends substantially from the receiving segment forward end to the vessel open end.

### BRIEF DESCRIPTION OF THE DRAWINGS

Various other objects, advantages, and features of the invention will become apparent to those skilled in the art from the following discussion taken in conjunction with the following drawings, in which:

FIG. 1 is a side view of the fixed version of the loading and unloading assembly preferred embodiment at the open end of a secondary containment vessel with the vessel door closed, with a ton supply cylinder shown on the roller track in broken lines.

FIG. 2 is a top view of the version shown in FIG. 1, except that the vessel door is shown open.

FIG. 3 is a rearward end view of the version shown in FIG. 2.

FIG. 4 is a top view of a double track fixed version of the loading and unloading assembly preferred embodiment mounted at the open ends of two secondary containment vessels, with one vessel door open and the other vessel door closed.

FIG. 5 is a side view of the double track fixed version shown in FIG. 4.

FIG. 6 is a rearward end view of the version shown in FIG. 5.

FIG. 7 is a top view of the single track rolling version of the having caster wheels at both ends of each supporting structure.

FIG. 8 is a side view of the single track rolling version of FIG. 7.

FIG. 9 is a rearward end view of the version shown in FIG. 7.

FIG. 10 is a side view of a preferred type of caster wheel bolted to the lower surface of an I-beam track support structure.

### DETAILED DESCRIPTION OF THE PREFERRED EMBODIMENTS

As required, detailed embodiments of the present invention are disclosed herein; however, it is to be understood that the disclosed embodiments are merely exemplary of the invention which may be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure.

Reference is now made to the drawings, wherein like characteristics and features of the present invention shown in the various FIGURES are designated by the same reference numerals.

### First Preferred Embodiment

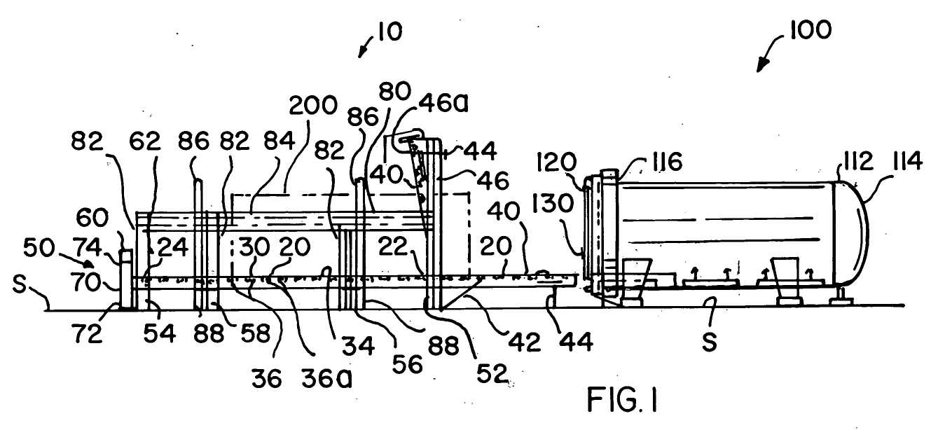

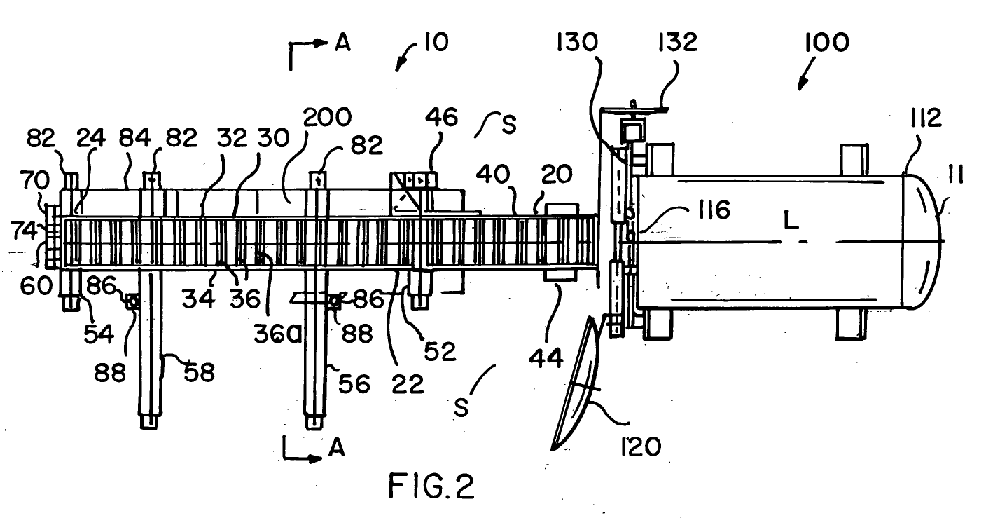

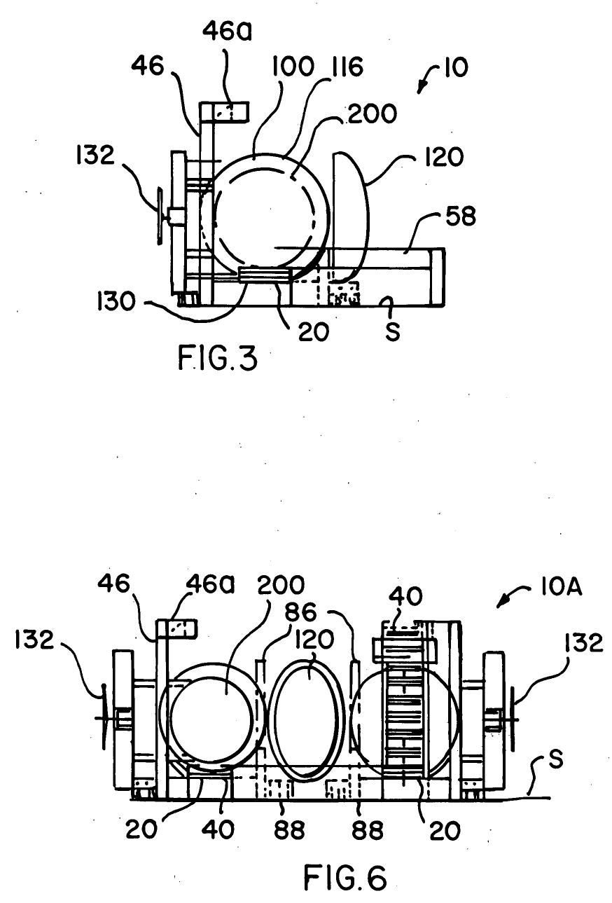

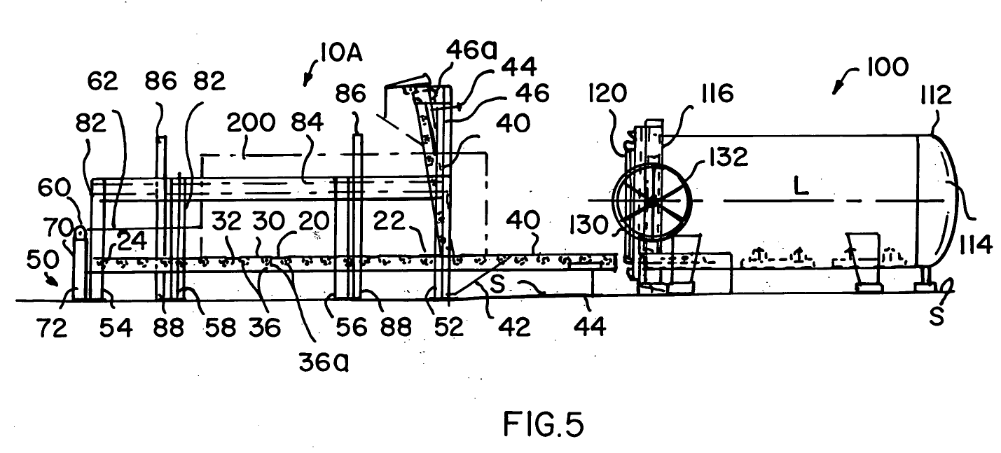

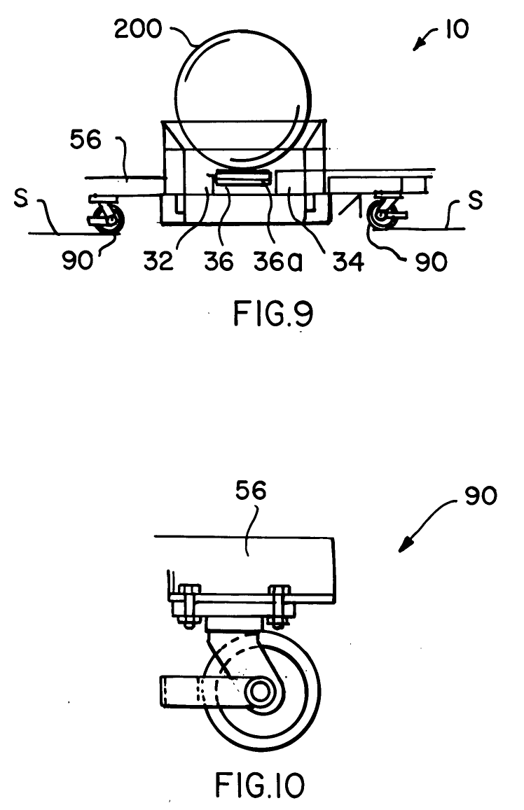

Referring to FIGS. 1-10, a loading assembly 10 is disclosed for longitudinally displacing heavy gas cylinders 200, such as ton chlorine supply cylinders, into and out of an open end 116 of a secondary containment vessel 100, the secondary containment vessel 100 typically having a substantially horizontal tubular side wall 110 with a vessel longitudinal axis L and a vessel closed end 112 with a vessel end wall 114 opposite the vessel open end 116, the vessel open end 116 being fitted with a vessel hinged door 120 which may be opened and closed by manually rotating a wheel 132 on a threaded drive rod assembly 130. The loading assembly 10 includes a substantially horizontal roller track 20 for positioning co-axially in front of and spaced outwardly from the vessel open end 116. The roller track 20 includes a track receiving segment 30 having a receiving segment forward end 22 directed toward the vessel open end 116 and an opposing receiving segment rearward end 24, and includes a separate track pivoting bridge segment 40 at the receiving segment forward end 22 preferably pivotally connected to the receiving segment forward end 22, for pivoting from an upward non-deployed position to a substantially horizontal deployed position in which the bridge segment 40 extends co-axially with the receiving segment 30 from the receiving segment forward end 22 to the vessel open end 116. A bridge segment support structure 44 preferably in the form of a short length of I-beam is fastened underneath the bridge segment 40 free end to hold the bridge segment 40 level with receiving segment 30. The low friction of the roller track 20 permits workers to manually push a heavy cylinder 200 into the vessel 100. A winch 60 is secured to a winch mounting structure 70, at the receiving segment rearward end 24, the winch 60 having a winch cable 62 which is connected to a turnbuckle positioned within the chine of ton supply cylinder 200 to pull the cylinder 200 out of the vessel 100 after the contents of the cylinder 200 are drained. In most instances, the cylinder 200 is leaking or is in danger of leaking a hazardous fluid, and therefore is sealed within the vessel 100 and drained into a safe receiving structure. Assembly 10 and vessel 100 are shown resting on a support surface S such as a building floor.

The receiving segment 30 and the bridge segment 40 of roller track 20 preferably includes two laterally spaced apart and parallel track rails 32 and 34 interconnected by a series of equally spaced rollers 36, each roller 36 being rotatably mounted on a roller axle 36a extending between and into the track rails 32 and 34. Preferred types of stock roller track 20 are the Model 251SR and Model 251SRC GRAVITY ROLLER CONVEYOR produced by AUTOMATED CONVEYOR SYSTEM, INC™. The rollers 36 preferably are corrosion resistant and individually replaceable when worn or damaged. A rail structural member 38 extends between the two track rails 32 and 34 at each segment 30 and 40 end to hold the track rails 32 and 34 at a fixed spacing from each other and to provide structural strength and integrity to the roller track 20.

The track rails 32 and 34 rest on and are fastened to a spaced series of track support structures 50 preferably in the form of I-beams extending perpendicularly underneath the track rails 32 and 34 of the receiving segment 30 which elevate and support the roller track 20. A rearward track support structure 54 is provided underneath the receiving segment rearward end 24 and a forward track support structure 52 is provided underneath the receiving segment forward end 22, and first and second middle support structures 56 and 58 are provided underneath the roller track 20 between the forward and rearward track support structures 52 and 54, respectively.

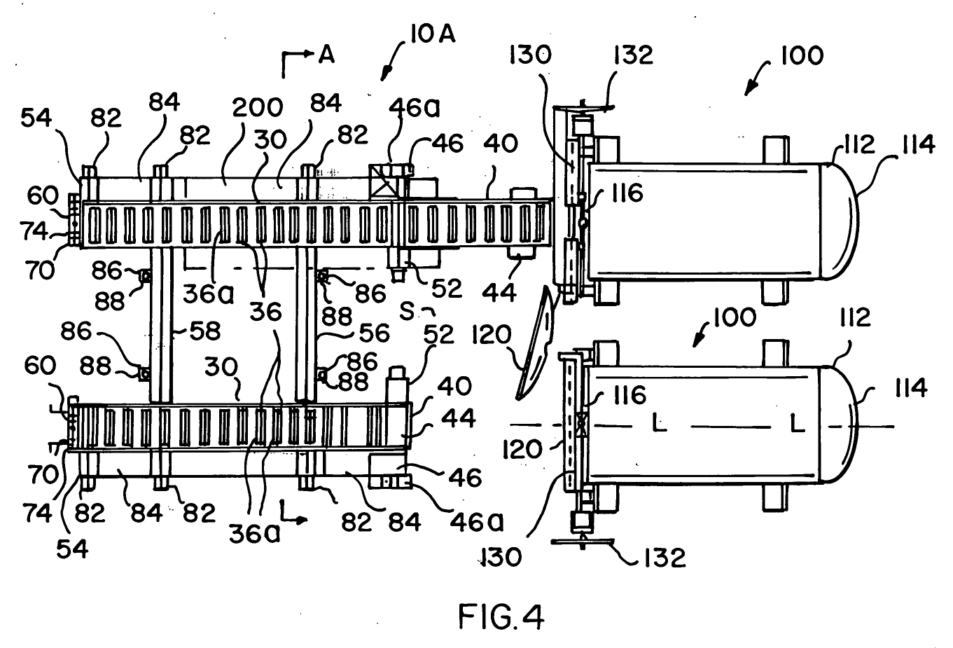

First and second middle support structures 56 and 58 preferably extend laterally so that storing so that at least one cylinder 200 can be placed on the first and second middle support structures 56 and 58 laterally adjacent to the receiving segment 30. See FIGS. 1-3. To retain the one or more cylinders 200 on the first and second middle support structures 56 and 58, upright retaining posts 86 are removably fitted into open tops of post receptacles 88. Alternatively the first and second middle track support structures 56 and 58 extend laterally so that a second roller track 20A can be placed parallel to the first roller track 20. In this way, a multiple track assembly 10A such as a double track assembly illustrated in FIGS. 4-6 is optionally provided, so that multiple secondary containment vessels 100 can be placed in tandem with each other and loaded and unloaded by the assembly 10A after being sealed within vessel 100.

Gas springs 42 preferably extend a point on bridge segment 40 spaced forwardly from receiving segment forward end 22 to the forward track support structure 52 to provide an upward force against and thus to assist in manually lifting of bridge segment 40. A preferred gas spring 42 is the Type 316 produced by MCMASTER-CARR™. A bridge segment stop post 46 preferably extends upwardly adjacent to the receiving segment forward end 22 and a post lateral arm 46a at the stop post 46 upper end extends over receiving segment forward end 22. The bridge segment 40 pivots upwardly until the bridge segment 40 free end abuts the post lateral arm 46a, and then is releasibly secured to the post lateral arm 46a by a spring clip (not shown).

A fence 80 preferably is provided along the side of the roller track 20 opposite the side on which the middle support structures 56 and 58 extend laterally, for retaining a cylinder 200 resting on the roller track 20 against laterally rolling. The fence 80 includes four upright fence posts 82 interconnected by a horizontal top rail 84.

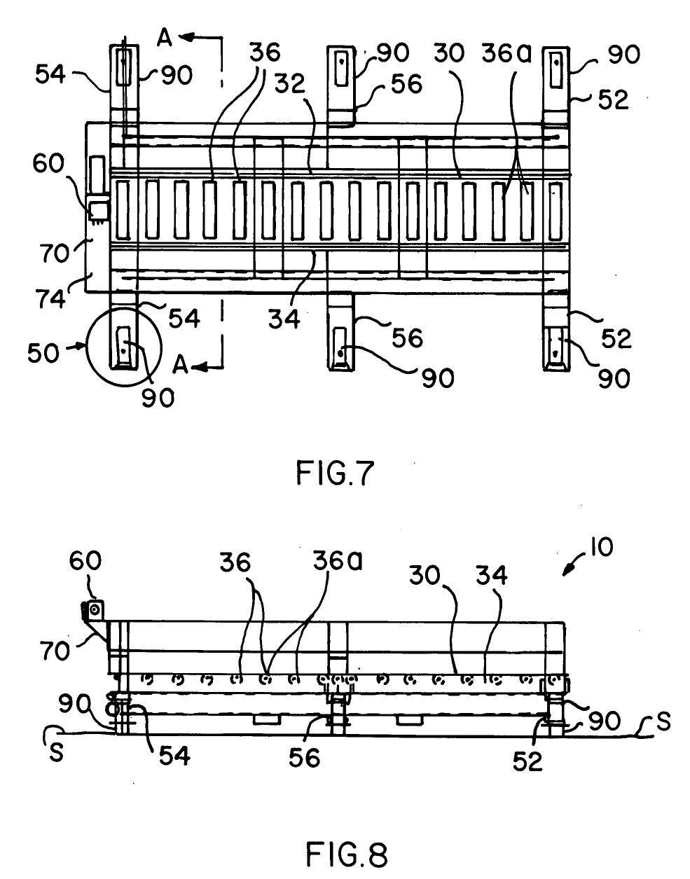

A rolling version of loading assembly 10 is provided for use in facilities which do not have floor space to permanently dedicate to a loading assembly 10. The rolling version includes caster wheels 90 secured to and extending downwardly from the lateral ends of support structures 52-58. See FIGS. 7-9. A preferred type of caster wheel 90 is CASTERS TP7100 produced by TRIOPINES CASTERS™, and can be locked to prevent movement of the loading assembly 10 during use. The winch mounting structure 70 preferably includes two upright mounting structure posts 72 and a mounting structure cross-bar 74 on which the winch 60 is mounted.

The secondary containment vessel 100 preferably is a high pressure containment vessel for receiving and safely enclosing a supply cylinder 200 having a supply cylinder release valve (not shown) and containing a hazardous fluid substance at a pressure above ambient. A high pressure flex line (not shown) extends from the supply cylinder release valve to an automatic gas sensing valve assembly (not shown) mounted in a vessel port in the vessel 100 wall. The gas sensing valve assembly (not shown) automatically shuts off the flow of gas at the vessel port when a gas leak is detected outside the containment vessel 100, or in the event of seismic activity and power failure. Gas drained from the cylinder 200 passes through the valve assembly and into a receiving structure or system, such as a gas chlorinator. Further descriptions of the preferred secondary containment vessel 100 may be found in prior U.S. Pat. Nos. 5,607,384 and 5,819,787 issued to the present applicant.

While the invention has been described, disclosed, illustrated and shown in various terms or certain embodiments or modifications which it has assumed in practice, the scope of the invention is not intended to be, nor should it be deemed to be, limited thereby and such other modifications or embodiments as may be suggested by the teachings herein are particularly reserved especially as they fall within the breadth and scope of the claims here appended.

I claim as my invention:

1. An assembly for loading and unloading supply cylinders containing a hazardous fluid substance into and out of a secondary containment vessel having a substantially horizontal tubular side wall with a vessel longitudinal axis and a vessel closed end with a vessel end wall opposite a vessel open end, the vessel open end being fitted with a vessel hinged door, comprising:
a substantially horizontal roller track for positioning substantially co-axially in front of and spaced outwardly from the vessel open end, said roller track comprising a receiving segment having a receiving segment forward end directed toward the vessel open end and having an opposing receiving segment rearward end, and comprising a track bridge segment pivotally mounted at said receiving segment forward end, for pivoting from non-deployed position to a substantially horizontal deployed position in which said bridge segment extends substantially from said receiving segment forward end to the vessel open end.

2. The assembly of claim 1, additionally comprising a winch mounting structure and a winch secured to said winch mounting structure, said winch having a winch cable for connection to a turnbuckle positioned within the chine of ton cylinder to displace the supply cylinder longitudinally along said roller track and out of the secondary containment vessel.

3. The assembly of claim 2, wherein said winch mounting structure is positioned at said receiving segment rearward end.

4. The assembly of claim 1, wherein said bridge segment is pivotally connected to said receiving segment forward end.

5. The assembly of claim 1, wherein said receiving segment and said bridge segment of said roller track each comprise two laterally spaced apart and substantially parallel track rails interconnected by a series of spaced rollers, each said roller being rotatably mounted on a roller axle extending between and into said track rails.

6. The assembly of claim 5, additionally comprising a rail structural member extending between said track rails at each longitudinal end of said receiving segment to hold the track rails at a fixed spacing from each other and to provide structural strength and integrity to said receiving segment.

7. The assembly of claim 5, additionally comprising a spaced series of track support structures, wherein said track rails rest on and are fastened to said track support structures for elevating and supporting said receiving segment of said roller track.

8. The assembly of claim 7, wherein said track support structures each comprise an I-beam extending substantially perpendicularly underneath said receiving segment of said roller track.

9. The assembly of claim 7, wherein said track support structures comprise:
a rearward track support structure underneath said receiving segment rearward end and a forward track support structure underneath said receiving segment forward end.

10. The assembly of claim 7, wherein said track support structures comprise:
a first middle support structure and a second middle support structure underneath said receiving segment of said roller track between said rearward track support structure and said forward track support structure, wherein said first and second middle support structures extend laterally from said receiving segment of said roller track, such that at least one cylinder can be placed on said first and second middle support structures laterally adjacent to said receiving segment.

11. The assembly of claim 7, wherein said track support structures comprise:
a first middle support structure and a second middle support structure underneath said receiving segment of said roller track between said rearward track support structure and said forward track support structure, wherein said first and second middle support structures extend laterally from said receiving segment of said roller track, such that a second roller track can be placed parallel to said roller track and two secondary containment vessels can be placed in tandem with each other and loaded and unloaded by said roller track and said second roller track.

12. A secondary containment and loading system for supply cylinders, comprising:
a secondary containment vessel having a substantially horizontal tubular side wall with a vessel longitudinal axis and a vessel closed end with a vessel end wall opposite a vessel open end, the vessel open end being fitted with a vessel hinged door;
and a loading assembly for loading and unloading supply cylinders containing a hazardous fluid substance into and out of a secondary containment vessel comprising a substantially horizontal roller track for positioning substantially co-axially in front of and spaced outwardly from the vessel open end, said roller track comprising a receiving segment having a receiving segment forward end directed toward the vessel open end and having an opposing receiving segment rearward end, and comprising a track bridge segment pivotally mounted at said receiving segment forward end, for pivoting from non-deployed position to a substantially horizontal deployed position in which said bridge segment extends substantially from said receiving segment forward end to the vessel open end.
